(19) United States
(12) Patent Application Publication
(10) Pub. No.: US 2021/0350974 A1
(43) Pub. Date: Nov. 11, 2021

(54) WINDING ASSEMBLY AND MAGNETIC ELEMENT

(71) Applicant: Delta Electronics (Shanghai) CO., LTD, Shanghai (CN)

(72) Inventors: Haibin SONG, Shanghai (CN); Qi FU, Shanghai (CN); Daofei XU, Shanghai (CN); Jinfa ZHANG, Shanghai (CN)

(73) Assignee: Delta Electronics (Shanghai) CO., LTD, Shanghai (CN)

(21) Appl. No.: 17/232,531

(22) Filed: Apr. 16, 2021

(30) Foreign Application Priority Data
May 7, 2020 (CN) 202020730297.8

(51) Int. Cl. H01F 27/28; H01F 27/24

(52) U.S. Cl. CPC H01F 27/2804; H01F 2027/2809; H01F 27/24

(57) ABSTRACT

Present disclosure provides a winding assembly and a magnetic element. The winding assembly comprises a substrate with a central hole and a first winding disposed in the substrate, the first winding comprising two layers of coil wound around a central hole in the substrate; wherein, a second end of a first layer of coil away from the central hole is connected to a first end of a second layer of coil away from the central hole, and a first end of the first layer of coil close to the central hole and a second end of the second layer of coil close to the central hole serve as a starting-end and a finishing-end of the first winding, respectively. The magnetic element comprises a winding assembly and a magnetic core, and the winding assembly is sleeved on a magnetic leg of the magnetic core.

### CROSS REFERENCE

This application is based upon and claims priority to Chinese Patent Application No. 202020730297.8, filed on May 7, 2020, the entire content of which is incorporated herein by reference.

### TECHNICAL FIELD

The disclosure relates to the technical field of power electronics, in particular, to a winding assembly and a magnetic element.

### BACKGROUND

Miniaturization and high power density have become the development trend of switching mode power supplies. Magnetic elements such as inductors or transformers, are important in switching mode power supply. In order to meet requirements of miniaturization, planar transformers have been widely used. The higher the switching frequency, the smaller the size of the transformer. Planar transformers have obvious advantages in volume and flexibility over traditional transformers. However, a parasitic capacitor generated between turns of coil in existing planar transformer is large, which affects efficiency of the switching mode power supplies and improvement of high power density.

The above information disclosed in the Background section is only for enhancing the understanding of the background of the present disclosure, so it may include information that does not constitute prior art known to those of ordinary skill in the art.

### SUMMARY

The present disclosure provides a winding assembly and a magnetic element winding assembly.

Other characteristics and advantages of the present disclosure will become apparent from the following detailed description, or partly learned through the practice of the present disclosure.

According to an aspect of the present disclosure, there is provided a winding assembly, including a substrate and a first winding disposed in the substrate, the first winding including two layers of coil wound around a central hole in the substrate; wherein, in the two layers of coil, an end of a first layer of coil away from the central hole is connected to an end of a second layer of coil away from the central hole, and an end of the first layer of coil close to the central hole and an end of the second layer of coil close to the central hole serve as a starting-end and an end of the first winding, respectively.

According to another aspect of the present disclosure, there is provided a magnetic element, including a winding assembly and a magnetic core, the winding assembly being sleeved on a magnetic leg of the magnetic core; the winding assembly includes a substrate and a first winding disposed in the substrate, the first winding including two layers of coil wound around a central hole in the substrate; wherein, in the two layers of coil, an end of a first layer of coil away from the central hole is connected to an end of a second layer of coil away from the central hole, and an end of the first layer of coil close to the central hole and an end of the second layer of coil close to the central hole serve as a starting-end and an end of the first winding, respectively.

It should be understood that the above general description and the following detailed description are only exemplary and do not limit the present disclosure.

### BRIEF DESCRIPTION OF THE DRAWINGS

The above and other objects, features, and advantages of the present disclosure will become more apparent by describing in detail exemplary embodiments thereof with reference to the accompanying drawings.

FIG. 1 is a schematic structural diagram of a winding assembly according to an exemplary embodiment.

FIG. 2 is a schematic diagram of winding a coil according to an exemplary embodiment.

FIG. 3 is a schematic structural diagram of another winding assembly according to an exemplary embodiment.

FIG. 4 is a schematic cross-sectional view of another winding assembly according to an exemplary embodiment.

FIG. 5 is an exploded view of a magnetic element according to an exemplary embodiment.

### DETAILED DESCRIPTION

Example embodiments will now be described more fully with reference to the drawings. However, the exemplary embodiments may be implemented in various forms and should not be construed as being limited to examples set forth herein; on the contrary, these embodiments are provided to make the present disclosure more comprehensive and complete, and to fully convey concept of the exemplary embodiments to those skilled in the art. The drawings are only schematic diagrams of the present disclosure and are not necessarily drawn to scale. The same reference numerals in the drawings denote the same or similar parts, and thus their repeated description will be omitted.

Furthermore, the described features, structures, or characteristics may be combined in one or more embodiments in any suitable manner. In the following description, many specific details are provided to give a full understanding of the embodiments of the present disclosure. However, those skilled in the art will realize that the technical solutions of the present disclosure may be practiced with omitting one or more of the specific details, or other methods, components, devices, steps, etc. may be used. In other cases, well-known structures, methods, devices, implementations, or operations are not shown or described in detail to avoid obscuring the subject and obscuring aspects of the present disclosure.

The terms “first” and “second” are used for descriptive purposes only and may not be understood as indicating or implying relative importance or implicitly indicating the number of technical features indicated. Thus, the features defined as “first” and “second” may explicitly or implicitly include one or more of the features.

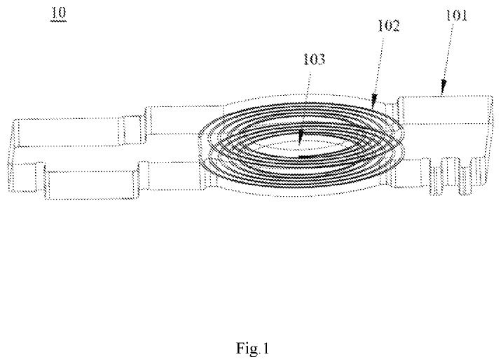

FIG. 1 is a schematic structural diagram of a winding assembly according to an exemplary embodiment.

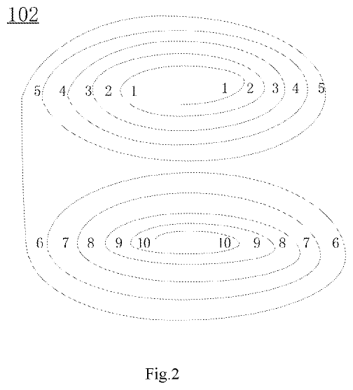

FIG. 2 is a schematic diagram of winding according to an exemplary embodiment.

As shown in FIGS. 1 and 2, a winding assembly 10 includes a substrate 101 with a central hole 103 and a first winding 102 disposed in the substrate 101. The first winding 102 including two layers of coil wound around the central hole 103 in the substrate 101. In some embodiments, the substrate may be Printed. Circuit Board (PCB). Wherein, a second end of a first layer of coil away from the central hole 103 is connected to a first end of a second layer of coil away from the central hole 103, and a first end of the first layer of coil close to the central hole 103 and a second end of the second layer of coil close to the central hole 103 serve as a starting-end and a finishing-end of the first winding 102, respectively.

In the winding assembly 10 shown in FIGS. 1 and 2, the first winding 102 is located in two layers of the substrate 101 and has five turns per layer as an example, and the present disclosure is not limited thereto. As shown in FIGS. 1 and 2, in the present disclosure, 1 represents a first turn of coil, 2 represents a second turn of coil, and so on. Ten turns of coil (1 to 10) surround the central hole 103, five turns of coil (1 to 5) are the first layer of coil, and five turns of coil (6 to 10) are the second layer of coil. For example, the first layer of coil is wound from a side close to the central hole 103 to a side away from the central hole 103, that is, wound in an order of turn 1 to turn 5; the second layer of coil is wound from the side away from the central hole 103 to the side close to the central hole 103, that is, wound in an order of turn 6 to turn 10; the second end of the first layer of coil away from the central hole 103 is connected to the first end of the second layer of coil away from the central hole 103, that is, the turn 5 and the turn 6 are connected. As shown in FIGS. 1 and 2, each of the five turns (1 to 5) of the first layer of coil is disposed in a first plane in the substrate, and each of the five turns (6 to 10) of the second layer of coil is disposed in a second plane parallel to the first plane in the substrate. Further, the turns in the first layer of coil is partially overlapped with the turns in the second layer of coil in a direction perpendicular to the first and second plane. As shown in FIGS. 1 and 2, each turn (e.g., turn 1) of the first layer of coil is disposed partially overlapping with each turn (e.g., turn 10) of the second layer of coil. The turns overlapping each other may be referred to a set (or a pair) of turns opposite to each other.

In some embodiments, the second end of the first layer of coil away from the central hole and the first end of the second layer of coil away from the central hole are connected through a via hole, that is, the turn 5 and the turn 6 are connected through the via hole in the substrate. Wherein, there may be one or more via holes, which is not limited by the present disclosure.

In some embodiments, materials of the substrate between the first layer of coil and the second layer of coil may play an insulation role. In other embodiments, an insulation layer may be additionally disposed between the first layer of coil and the second layer of coil, and the present disclosure is not limited thereto.

In some embodiments, the first layer of coil and the second layer of coil may be formed by winding a wire, and a starting-end and a finishing-end of the wire are located close to the central hole. For example, still taking the winding assembly shown in FIGS. 1 and 2 as an example, the turn 1 is the starting-end of the winding, turn 10 is the finishing-end of the winding, and both the turn 1 and turn 10 are located the side close to central hole 103. The two layers of coil is formed by one wire, that is, one wire may be considered to be located in the first layer of the substrate, and wound from the side close to the central hole 103 (turn 1) to the side away from the central hole 103 (turn 5), passed to the second layer of the substrate, and then, wound from the side away from the central hole 103 (turn 6) to the side close to the central hole 103 (turn 10). The completed coil is shown in FIG. 2. The substrate between the first layer of coil and the second layer of coil may play an insulation role. A voltage between the turn 1 and the turn 10 is relatively large, and a voltage between the turn 5 and the turn 6 is relatively small.

Specifically, a parasitic capacitor of the winding assembly in the substrate may be determined by the following equation:

$${C}_{p} = {\sum }_{x = 1}^{i} ( {C}_{{p}_{x}} \times \frac{{V}_{{p}_{x}}}{{V}_{p}} ) \qquad Equation ( 1 )$$

wherein, Cₚ is an overall parasitic capacitor between two layers of coil in the substrate, Cₚ_{ₓ} is a single parasitic capacitor between turns opposite to each other. Vₚ_{ₓ} is a voltage between the turns opposite to each other, Vₚ is a voltage between a starting-end and a finishing-end of the two layers of coil in the substrate, and i is the number of sets of the turns opposite to each other.

Cₚ_{ₓ} may be determined by the following equation:

$${C}_{{P}_{x}} = ɛ \frac{{S}_{x}}{d} \qquad Equation ( 2 )$$

wherein, ε is a dielectric constant determined by the material of the substrate; Sₓ is a facing area of the turns opposite to each other; d is a distance between the turns opposite to each other.

Taking the first winding with 10 turns shown in FIGS. 1 and 2 as an example, the turn 1 and the turn 10, which are a set of turns opposite to each other, are arranged at an inner loop with a smaller radius, a smaller circumference, and a smaller facing area, so that the parasitic capacitor between the set of turns (1, 10) opposite to each other is smaller; the turn 5 and the turn 6, which are a set of turns opposite to each other, are arranged at an outer loop with a larger radius, a larger circumference, and a larger relative area, so that the parasitic capacitor between the set of turns (5, 6) opposite to each other is larger.

In addition, the voltage between the turn 1 and the turn 10 is a voltage at the starting-end and the finishing-end of the first winding, so the voltage between the turn 1 and the turn 10 is larger, and the voltage between the turn 5 and the turn 6 is smaller; the single parasitic capacitor of the turns opposite to each other (turn 1 and turn 10) with a larger voltage is smaller, and the single parasitic capacitor of the turns opposite to each other (turn 5 and turn 6) with a smaller voltage is larger. With this arrangement, a product of the voltage and the parasitic capacitor of the turns opposite to each other is smaller, and the overall parasitic capacitor Cₚ of the entire winding assembly is smaller.

In summary, in this application, a starting-end and a finishing-end of the first winding 102 in the substrate 101 are disposed close to a central leg of the magnetic core, which may effectively reduce the parasitic capacitance and improve the conversion efficiency.

In some embodiments, the first end of the first layer of coil close to the central hole 103 and the second end of the second layer of coil close to the central hole 103 are used to connect to an external circuit or device, that is, the starting-end and the finishing-end of the winding 102 are connected to the external circuit or device.

The winding assembly 10 may be applied to magnetic elements, such as inductors and transformers. The transformer may be of any known type, such as a PCB planar transformer. In some embodiments, users may use the two layers of coil as a primary winding of the PCB planar transformer or the two layers of coil as a secondary winding of the PCB planar transformer according to product requirements.

In the embodiment of the present disclosure, in the winding assembly, the second end of the first layer of coil away from the central hole is connected to the first end of the second layer of coil away from the central hole, and the first end of the first layer of coil close to the central hole and the second end of the second layer of coil close to the central hole serve as the starting-end and the finishing-end of the first winding, respectively. This winding method may reduce the overall parasitic capacitor of the winding assembly and improve the conversion efficiency.

It should be clearly understood that the present disclosure describes how to form and use specific examples, but the principle of the present disclosure is not limited to any details of these examples. On the contrary, based on the teaching of the disclosure of the present disclosure, these principles may be applied to many other embodiments.

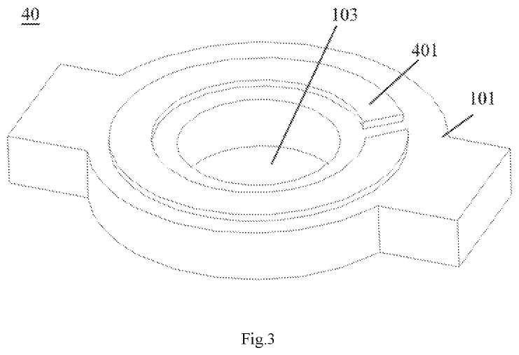

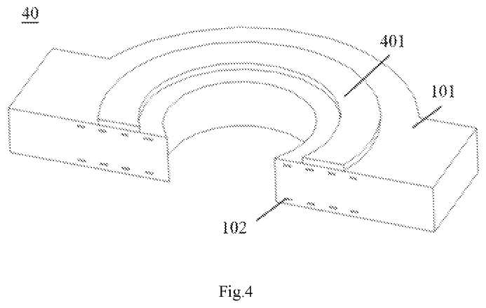

FIG. 3 is a schematic structural diagram of another winding assembly according to an exemplary embodiment. FIG. 4 is a schematic cross-sectional view of another winding assembly according to an exemplary embodiment.

As shown in FIGS. 3 and 4, the winding assembly 40 includes a substrate 101 and a first winding (not shown) disposed in the substrate 101, the first winding including two layers of coil wound around a central hole 103 in the substrate; the winding assembly 40 further includes a second winding 401 with at least one layer of coil. The first winding 102 is insulated from the second winding 401. In this embodiment, the two layers of coil of the first winding 102 is disposed in middle layer of the substrate 101, and the coil of the second winding 401 is disposed in a surface layer of the substrate 101. Wherein, a second end of a first layer of coil away from the central hole 103 and a first end of a second layer of coil away from the central hole 103 of the first winding are connected as described above and will not be expanded here. In FIG. 3, the second winding includes one turn. In other embodiments, the second winding may include a plurality of turns. In some embodiments, the second winding 401 may be a flat copper coil.

Further, in some embodiments, the second winding 401 may include two layers of coil, which are stacked on upper and lower sides of the first winding, that is, the two layers of coil of the second winding 401 are located in a first layer and a last layer of the substrate 101 respectively, and the two layers of coil of the first winding is located in middle layers of the substrate 101. In other embodiments, the two layers of coil of the first winding 102 may be located in the first layer and the last layer of the substrate 101 respectively, and the two layers of coil of the second winding 401 may be located in the middle layers of the substrate 101, which is not limited by the present disclosure. Further, the two layers of coil of the second winding 401 may be connected through a via hole, and the number of turns of each layer of coil 401 may be one or more turns.

The winding assembly 40 may be applied in a transformer, for example, and the transformer may be of any known type, such as a PCB planar transformer. In some embodiments, the first winding may be used as a primary winding of the PCB planar transformer and the second winding may be used as a secondary winding of the PCB planar transformer according to product requirements; or the first winding may be used as the secondary winding of the PCB planar transformer, and the second winding may be used as the primary winding of the PCB planar transformer. The primary winding is connected to a primary switch, and the secondary winding is connected to a secondary switch. The primary switch and the secondary switch may be disposed on the substrate.

Further, the primary switch and/or the secondary switch may be located closer to the coil due to the starting-end and the finishing-end of the first winding is located near the central hole of the substrate. In some embodiments, the primary switch may be disposed on the substrate and connected to starting-end or the finishing-end of the first winding, a projection of the primary switch on the substrate may be at least partially overlapped with a projection of the primary winding. So the primary switch may get closer to the magnetic core to reduce the primary loop, which is formed by the input bus capacitor, the primary switch and the primary winding, thereby reducing the leakage inductance caused by the primary loop. Thus the efficiency of the switching mode power supply is also improved and the size of the switching mode power supply is further reduced. However, the present disclosure is not limited thereto. In some other embodiments, the secondary switch may be disposed on the substrate and connected to starting-end or the finishing-end of the first winding, a projection of the secondary switch on the substrate may be at least partially overlapped with a projection of the secondary winding. So the secondary switch may get closer to the magnetic core to reduce the secondary loop, which is formed by the output capacitor, the secondary switch and the secondary winding, thereby reducing leakage inductance caused by the secondary loop. Thus the efficiency of the switching mode power supply is improved and the size of the switching mode power supply is further reduced.

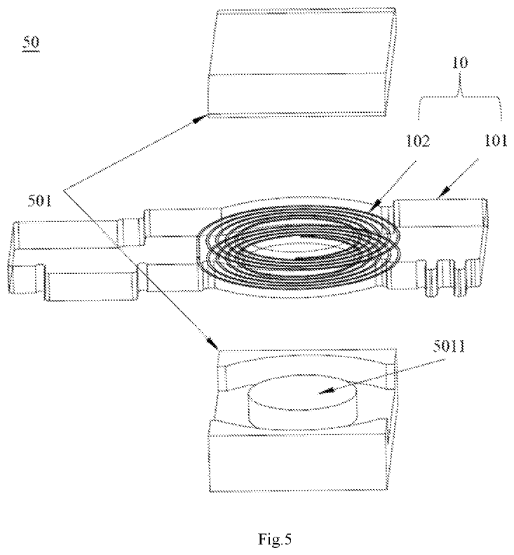

FIG. 5 is an exploded view of a magnetic element according to an exemplary embodiment. As shown in FIG. 5, a magnetic element 50 includes: a winding assembly 10 and a magnetic core 501, the winding assembly 10 being sleeved on a magnetic leg 5011 of the magnetic core 501; wherein, the winding assembly 10 includes a substrate 101 and a first winding 102 with two layers of coil wound around a central hole of the substrate 101; the schematic structural diagram of the winding assembly 10 is shown in FIG. 1 and FIG. 2 and will not be repeated here.

In some embodiments, a first layer of coil and a second layer of coil of the first winding 102 are insulated by the substrate serving as an insulation layer, or the insulation layer may be additionally disposed between the first layer of coil and the second layer of coil of the first winding 102.

In some embodiments, the second end of the first layer of coil away from the magnetic leg 5011 and the first end of the second layer of coil away from the magnetic leg 5011 are connected by a via hole. There may be one or more via holes, which is not limited by the present disclosure. In some embodiments, the first end of the first layer of coil close to the magnetic leg 5011 and the second end of the second layer of coil close to the magnetic leg 5011 are connected to an external circuit or device, that is, a starting-end and a finishing-end of the winding are connected to the external circuit or device.

In some embodiments, the first layer of coil and the second layer of coil are formed by winding a wire.

In some embodiments, the magnetic element 50 may be a PCB planar transformer. The two layers of coil may be as a primary winding of the PCB planar transformer or a secondary winding of the PCB planar transformer according to product requirements.

The magnetic core 501 may be made of, for example, a magnetic metal oxide composed of a mixture of iron oxide. For example, the magnetic core 501 may be made of manganese-zinc ferrite and nickel-zinc ferrite materials. The magnetic core 501 may have any suitable shape, for example, an “E” type magnetic core and the like.

In some embodiments, the magnetic core 501, the substrate 101 and the first winding 102 are coaxially assembled into the magnetic element 50.

In some embodiments, the magnetic element 50 may also use the winding assembly 40 shown in FIGS. 3 and 4. That is, the magnetic element 50 further includes a second winding 401, the second winding includes at least one layer of coil, and the second winding is insulated from the two layers of coil of the first winding 102. The at least one layer of coil of the second winding may have one or more turns. In some embodiments, the second winding 401 may include two layers of coil, and each layer of coil may have one or more turns. In some embodiments, the two layers of coil of the second winding are located in a first layer and a last layer of the substrate 101 respectively, and the two layers of coil of the first winding 102 are located in middle layers of the substrate. Alternatively, the two layers of coil of the first winding 102 are located in the first layer and the last layer of the substrate 101 respectively, and the two layers of coil of the second winding 401 are located in the middle layers of the substrate.

In some embodiments, the magnetic element 50 may be a PCB planar transformer, and the first winding may be used as a primary winding of the PCB transformer and the second winding may be used as a secondary winding of the PCB transformer according to product requirements. Alternatively, the first winding may be used as the secondary winding of the PCB transformer, and the second winding is used as the primary winding of the PCB transformer. The primary winding is connected to a primary switch, and the secondary winding is connected to a secondary switch. And the primary switch and the secondary switch are disposed on the substrate.

In the embodiment of the present disclosure, for the two layers of coil in the magnetic element, the second end of the first layer of coil away from the magnetic leg is connected to the first end of the second layer of coil away from the magnetic leg. This winding method may reduce the overall parasitic capacitor of the winding assembly in the magnetic element and improve the conversion efficiency.

It should be noted that the block diagrams shown in the above drawings are functional entities and do not necessarily correspond to physically or logically independent entities. These functional entities may be implemented in the form of software, or implemented in one or more hardware modules or integrated circuits, or implemented in different networks and/or processor devices and/or microcontroller devices.

The exemplary embodiments of the present disclosure are specifically shown and described above. It should be understood that the present disclosure is not limited to the detailed structure, arrangement, or implementation method described herein; on the contrary, the present disclosure is intended to cover various modifications and equivalent arrangements included within the spirit and scope of the appended claims.

What is claimed is:

1. A winding assembly, comprising:
a substrate with a central hole;
a first winding disposed in the substrate, the first winding comprising two layers of coil wound around a central hole in the substrate; wherein,
a second end of a first layer of coil away from the central hole is connected to a first end of a second layer of coil away from the central hole; and
a first end of the first layer of coil close to the central hole and a second end of the second layer of coil close to the central hole serve as a starting-end and a finishing-end of the first winding respectively.

2. The winding assembly according to claim 1, wherein, the second end of the first layer of coil away from the central hole and the first end of the second layer of coil away from the central hole are connected through a via hole.

3. The winding assembly according to claim 1, wherein, the first end of the first layer of coil close to the central hole and the second end of the second layer of coil close to the central hole are connected to an external circuit or device.

4. The winding assembly according to claim 1, wherein, the first layer of coil and the second layer of coil are formed by winding a wire.

5. The winding assembly according to claim 1, wherein each turn of the first layer of coil of the first winding is disposed in a first plane in the substrate, and each turn of the second layer of coil of the first winding is disposed in a second plane parallel to the first plane in the substrate.

6. The winding assembly according to claim 1, wherein each turn of the first layer of coil of the first winding is partially disposed overlapping with each turn of the second layer of coil of the first winding.

7. The winding assembly according to claim 1, further comprising:
a second winding disposed in the substrate; wherein, the second winding comprises at least one layer of coil, and the first winding is insulated from the second winding.

8. The winding assembly according to claim 7, wherein, the second winding comprises two layers of coil located in a first layer and a last layer in the substrate respectively; and the first winding are located in a middle layer of the substrate.

9. The winding assembly according to claim 8, wherein, the two layers of coil of the second winding are connected through a via hole.

10. A magnetic element, comprising: a winding assembly and a magnetic core, the winding assembly being sleeved on a magnetic leg of the magnetic core, wherein the winding assembly comprises:
a substrate with a central hole;
a first winding disposed in the substrate, the first winding comprising two layers of coil wound around a central hole in the substrate; wherein,
a second end of a first layer of coil away from the central hole is connected to a first end of a second layer of coil away from the central hole; and
a first end of the first layer of coil close to the central hole and a second end of the second layer of coil close to the central hole serve as a starting-end and a finishing-end of the first winding, respectively.

11. The magnetic element according to claim 10, wherein, the second end of the first layer of coil away from the central hole and the first end of the second layer of coil away from the central hole are connected through a via hole.

12. The magnetic element according to claim 10, wherein, the first end of the first layer of coil close to the central hole and the second end of the second layer of coil close to the central hole are connected to an external circuit or device.

13. The magnetic element according to claim 10, wherein, the first layer of coil and the second layer of coil are formed by winding a wire.

14. The magnetic element according to claim 10, wherein each turn of the first layer of coil of the first winding is disposed in a first plane in the substrate, and each turn of the second layer of coil of the first winding is disposed in a second plane parallel to the first plane in the substrate.

15. The magnetic element according to claim 10, wherein each turn of the first layer of coil of the first winding is disposed partially overlapping with each turn of the second layer of coil of the first winding.

16. The magnetic element according to claim 10, further comprising:
a second winding disposed in the substrate; wherein, the second winding comprises at least one layer of coil, and the first winding is insulated from the second winding.

17. The magnetic element according to claim 16, wherein, the magnetic element is a transformer, the first winding is a primary winding of the transformer, and the second winding is a secondary winding of the transformer; or the first winding is the secondary winding of the transformer and the second winding is the primary winding of the transformer.

18. The magnetic element according to claim 17, wherein, a primary switch is disposed on the substrate and connected with the primary winding; and a secondary switch is disposed on the substrate and connected with the secondary winding.

19. The magnetic element according to claim 16, wherein, the second winding comprises two layers of coil located in a first layer and a last layer in the substrate, respectively, and the two layers of coil in the first winding are located in a middle layer of the substrate.

20. The magnetic element according to claim 19, wherein, the two layers of coil in the second winding are connected through a via hole.
